(19) United States
(12) Patent Application Publication
(10) Pub. No.: US 2014/0071501 A1
(43) Pub. Date: Mar. 13, 2014

(54) DOCUMENT SCANNING MODULE, INTEGRAL SCANNING UNIT, DOCUMENT SCANNING UNIT, AUTOMATIC DOCUMENT FEEDER, AND IMAGE FORMING APPARTAUS

(71) Applicants: Shohei SHINKAWA, Tokyo (JP); Yoshiaki NAGAO, Kanagawa (JP); Tatsuaki NAGANO, Kanagawa (JP); Atsushi SUGAI, Kanagawa (JP); Masatoshi ISHIDA, Kanagawa (JP)

(72) Inventors: Shohei SHINKAWA, Tokyo (JP); Yoshiaki NAGAO, Kanagawa (JP); Tatsuaki NAGANO, Kanagawa (JP); Atsushi SUGAI, Kanagawa (JP); Masatoshi ISHIDA, Kanagawa (JP)

(73) Assignee: Ricoh Company, Limited, Tokyo (JP)

(21) Appl. No.: 13/975,668

(22) Filed: Aug. 26, 2013

(30) Foreign Application Priority Data
Sep. 7, 2012 (JP) 2012-196693

(51) Int. Cl. H04N 1/00

(52) U.S. Cl. CPC H04N 1/00525; H04N 1/00559
USPC 358/482

(57) ABSTRACT

A document scanning module includes an image sensor; and imaging lenses that focus light reflected from a document onto the image sensor to form an image. The imaging lenses include a front-group lens arranged on a document side, and a rear-group lens arranged on an image sensor side and having a width in a main-scanning direction. The rear-group lens includes an attachment portion extending toward the image sensor. The attachment portion is joined to a longitudinal side surface of the image sensor.

### CROSS-REFERENCE TO RELATED APPLICATIONS

The present application claims priority to and incorporates by reference the entire contents of Japanese Patent Application No. 2012-196693 filed in Japan on Sep. 7, 2012.

### BACKGROUND OF THE INVENTION

1. Field of the Invention

The present invention relates to a document scanning module provided to a document scanning unit included in an image forming apparatus, such as a copier, a printer, a facsimile, and a multifunction peripheral (MFP) having these functions.

2. Description of the Related Art

To reduce the size of a scanner unit, scanning units with an integrated image sensor are frequently provided with a short focus lens having a short conjugation length. By contrast, spherical lenses used as a conventional image reading lens need to have a long conjugation length so as to achieve high resolution. It is difficult to ensure a shorter focus and higher imaging performance.

To address this, Japanese Patent No. 3939908, for example, discloses a method for reducing the conjugation length and ensuring high imaging performance by grouping image reading lenses into a front group and a rear group and using a strip-shaped aspherical lens having a long side in a main-scanning direction as the rear group.

In the configuration of the image reading lens disclosed in Japanese Patent No. 3939908, for example, a positional relation between the rear-group lens and an image sensor is important. Japanese Patent Application Laid-open No. 2006-085003, for example, discloses a method for causing a lens surface to attach to a cover glass of an image sensor. Specifically, Japanese Patent Application Laid-open No. 2006-085003 discloses a method for fixing a rear-group lens to an image sensor by arranging a fixing member between the rear-group lens and the image sensor and then joining these components together so as to fix the rear-group lens to the image sensor.

The conventional method described above determines the positions of the rear-group lens and the image sensor in an optical axis direction (a z-direction) depending on the part accuracy of the fixing member and the rear-group lens. This may possibly prevent adjustment of the position of the rear-group lens, thereby preventing the relative position between the rear-group lens and the image sensor from being determined with high accuracy.

Therefore, there is a need for a document scanning module that has a short conjugation length and a small scanner unit and that ensures high imaging performance with a configuration capable of adjusting the relative position between a rear-group lens and an image sensor.

### SUMMARY OF THE INVENTION

According to an embodiment, there is provided a document scanning module that includes an image sensor; and imaging lenses that focus light reflected from a document onto the image sensor to form an image. The imaging lenses include a front-group lens arranged on a document side, and a rear-group lens arranged on an image sensor side and having a width in a main-scanning direction. The rear-group lens includes an attachment portion extending toward the image sensor. The attachment portion is joined to a longitudinal side surface of the image sensor.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of an example of an image forming apparatus including an illumination unit and an image reading device provided with the illumination unit according to the present invention;

FIG. 2 is a perspective view of an example of the image reading device;

FIG. 3 is a perspective view of an exemplary internal configuration of the image reading device illustrated in FIG. 2;

FIG. 4 is a sectional view illustrating an example of an integral scanning optical unit in detail;

FIG. 5 is a view for explaining the shape of a rear-group lens according to a comparative example used for comparison with the shape of a rear-group lens according to an embodiment of the present invention;

FIG. 6 is a view for explaining the shape of the rear-group lens according to the embodiment of the present invention; and

FIG. 7 is a view for explaining adjustment of the position of the rear-group lens.

### DETAILED DESCRIPTION OF THE PREFERRED EMBODIMENTS

Exemplary embodiments according to the present invention are described below with reference to the accompanying drawings.

To adjust and determine positions of an image sensor and a rear-group lens in a document reading lens grouped into a front group and a rear group, in an embodiment according to the present invention, the rear-group lens is provided with an attachment portion extending in an optical axis direction toward the rear-group lens. With this configuration, the relative position between the rear-group lens and the image sensor in the optical axis direction is adjusted, and the rear-group lens and the image sensor on the longitudinal side surface of the image sensor are joined together.

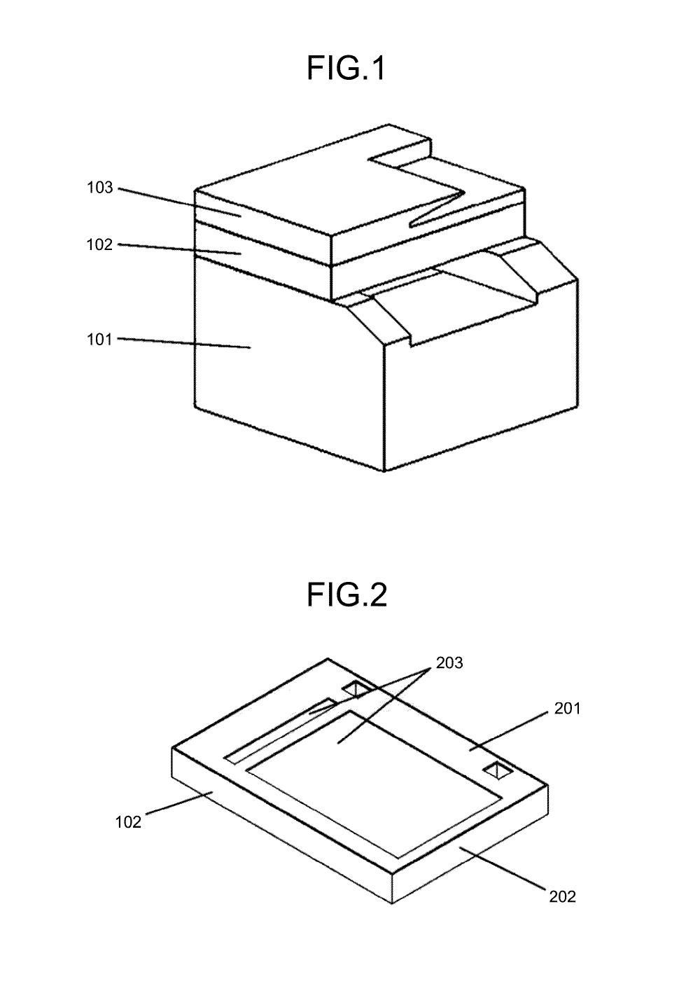

FIG. 1 is a perspective view of an example of an image forming apparatus including an illumination unit and an image scanning device provided with the illumination unit according to the present invention. As illustrated in FIG. 1, an image forming apparatus 101 includes an image scanning device 102 and a document feeder 103 arranged on top of the image scanning device 102.

FIG. 2 is a perspective view of an example of the image scanning device 102. The image scanning device 102 illustrated in FIG. 2 is formed of an upper frame 201 and a housing 202. The upper frame 201 is provided with an exposure glass 203 on which a document is placed.

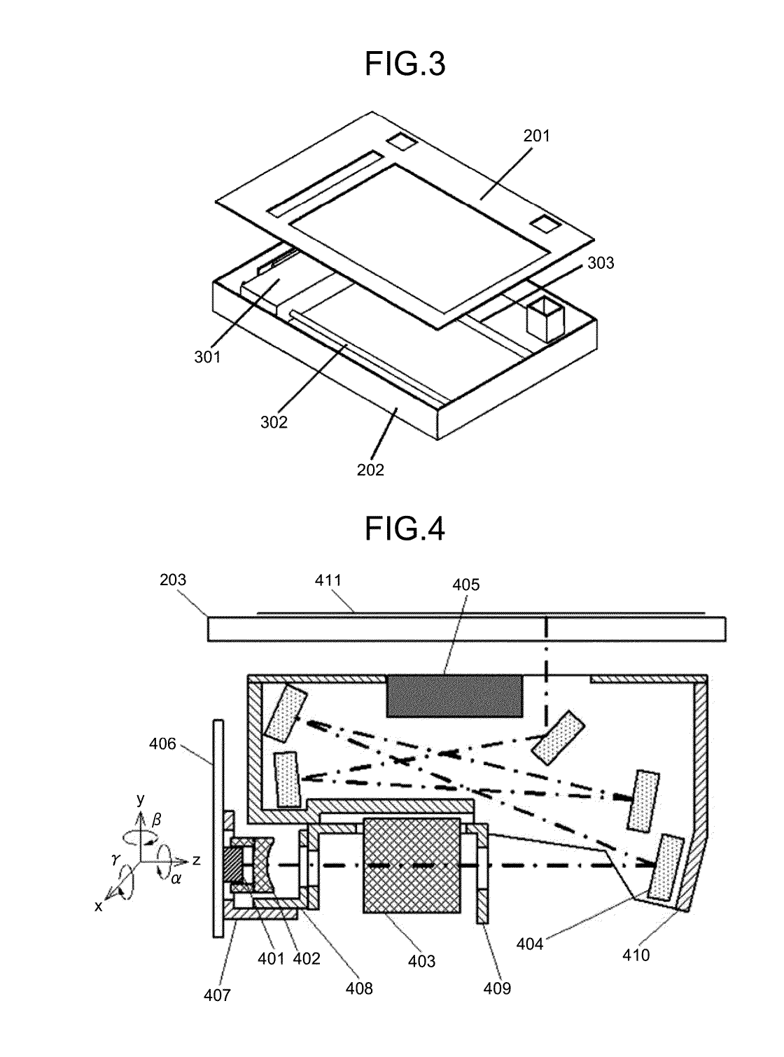

FIG. 3 is a perspective view of an exemplary internal configuration of the image scanning device 102 illustrated in FIG. 2. The image scanning device 102 includes an integral scanning optical unit 301 and guide rods 302 and 303. The integral scanning optical unit 301 includes an illumination, a lens, a charge-coupled device (CCD), a mirror, and an image sensor board, none of which is illustrated. The guide rods 302 and 303 are used in running of the integral scanning optical unit 301.

FIG. 4 is a sectional view illustrating an example of the integral scanning optical unit 301 in detail. The integral scanning optical unit 301 illustrated in FIG. 4 includes an illumination light source 405, a group of mirrors 404, a front-group lens 403, and a rear-group lens 402. The illumination light source 405 irradiates a document 411 with light. The group of mirrors 404 guides light reflected from the document 411 to an image sensor 401. The front-group lens 403 and the rear-group lens 402 focus the reflected light to form an image.

The front-group lens 403 is fixed to a lens support bracket 409, and the lens support bracket 409 is fixed to a carriage case 410. The image sensor 401 is mounted on a board 406, and the board 406 is fixed to an image sensor board support bracket 407. The image sensor board support bracket 407 is fixed to the lens support bracket 409 with an intermediate bracket 408.

In the present specification, a module including the image sensor 401, the rear-group lens 402, the front-group lens 403, the board 406, the image sensor board support bracket 407, the intermediate bracket 408, and the lens support bracket 409 fixed thereto is referred to as a document scanning module. The structure of the document scanning module according to the present invention is not limited to an integral optical scanning unit structure or an operating mirror structure.

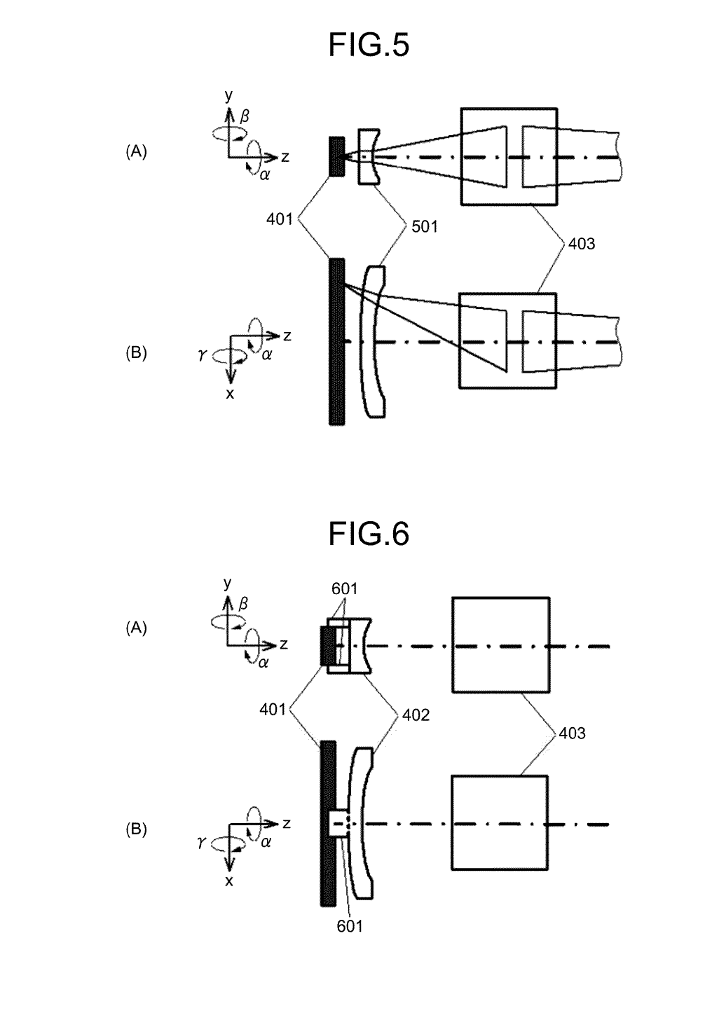

FIG. 5 is a view for explaining the shape of a rear-group lens according to a comparative example used for comparison with the shape of the rear-group lens according to the embodiment of the present invention, which will be described later. Section (A) in FIG. 5 is a front view of the shape of the rear-group lens according to the comparative example, and section (B) in FIG. 5 is a top view thereof.

In the comparative example, the front-group lens 403 is composed of a group of spherical or aspherical lenses, and the group of lenses is accommodated in a cylindrical lens tube. A rear-group lens 501 is arranged near an image surface. Because a light-receiving element array in the image sensor 401 is arranged on the image surface, the outer shape of the rear group need not be “rotationally symmetric about the optical axis”. In this case, the outer shape of the rear group may be “a strip shape having a long side in a main-scanning direction”.

The “main-scanning direction” corresponds to an array direction of the light-receiving elements in the image sensor 401 combined with the document reading lens. The image sensor 401 is formed of a CCD or a complementary metal-oxide semiconductor (CMOS), for example.

Because the rear-group lens 501 is arranged near the image surface in the document reading lens in the comparative example, the size of the rear-group lens 501 can be made larger than that of the front-group lens 403. In addition, making the rear-group lens 501 of plastic can further reduce cost of the document reading lens. Making the rear-group lens 501 of plastic also facilitates formation of an aspheric surface in the case where an aspheric surface is formed on at least one of the object side surface and the image side surface.

FIG. 6 is a view for explaining the shape of the rear-group lens according to the embodiment of the present invention. Section (A) in FIG. 6 is a front view of the shape of the rear-group lens according to the embodiment, and section (B) in FIG. 6 is a top view thereof.

As illustrated in FIG. 6, the rear-group lens 402 is provided with attachment portions 601 extending to the image sensor 401. The structure of the rear-group lens 402 is the same as that of the rear-group lens in the example of FIG. 5 other than the attachment portions. The attachment portions 601 are provided at positions in a y-direction in contact with the longitudinal side surfaces of the image sensor 401. The internal surfaces of the attachment portions 601 are joined to the longitudinal side surfaces of the image sensor 401, so that the positions of the rear-group lens 402 and the image sensor 401 in the y-direction is determined. Therefore, the length from the side surface of the image sensor 401 to the center of the light-receiving elements is preferably made equal to the length from the center of the rear-group lens 402 in the y-direction to the internal surface of the attachment portion 601. It is also preferable to make the tolerance as small as possible in fabrication.

The position of the rear-group lens 402 is determined not by adjusting its position in the y-direction but by using the part (i.e., the attachment portion). This is because the lens configuration according to the present invention requires higher accuracy positioning in x-, z-, and β-directions, which will be described later, than in the y-direction. Meanwhile, as illustrated in section (A) in FIG. 6, by providing the attachment portion 601 to both ends of the rear-group lens 501 in the short-length direction in a manner to sandwich the image sensor 401 in the short-length direction, the holding force is increased compared with the case where the attachment portion 601 is provided only to one end. This configuration can prevent the rear-group lens 402 from moving because of vibrations in scanning, thereby providing an excellent image.

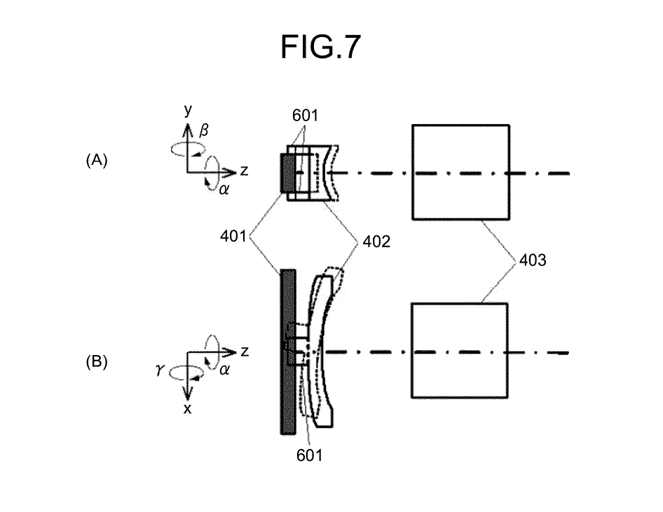

FIG. 7 is a view for explaining adjustment of the position of the rear-group lens. Section (A) in FIG. 7 is a front view of the rear-group lens according to the embodiment, and section (B) in FIG. 7 is a top view thereof. In the following description, an example is described in which the position of the rear-group lens indicated by a dashed line in FIG. 7 is adjusted to a target position indicated by a solid line in FIG. 7. The rear-group lens 402 is slid to move in the z-direction in section (A) in FIG. 7, whereby the positions of the rear-group lens 402 and the image sensor 401 are adjusted in the z-direction. At this time, rotating the rear-group lens 402 in the β-direction can adjust the relative position between the rear-group lens 402 and the image sensor 401 in the z-direction over the whole area in the main-scanning direction of the image sensor 401. Subsequently, the rear-group lens 402 is slid to move in the x-direction in section (B) in FIG. 7, whereby the center of the rear-group lens 402 is caused to coincide with the center of the image sensor 401. The position of the rear-group lens 402 with respect to the image sensor 401 is adjusted while measuring optical characteristics. The rear-group lens 402 is positioned at a position where a required characteristic value is obtained. After the adjustment, the attachment portions 601 of the rear-group lens 402 are bonded to the image sensor 401 with an adhesive or the like, whereby the rear-group lens 402 is fixed to the image sensor 401.

The package of the image sensor 401 is typically made of a metal material, such as a ceramic. There is no problem in, for example, providing a joint portion, at which the image sensor are joined together, to both ends of the image sensor in the short-length direction. However, providing the joint portion to both ends of the image sensor in the longitudinal direction (the main scanning direction) may possibly cause the following problem. Because the plastic lens is fixed to the ceramic with the adhesive or the like, difference in coefficient of liner expansion therebetween deforms the lens with a rise in temperature, resulting in detachment of the lens in the worst case. Even if the lens is not detached, deformation of the lens deteriorates the characteristics of the lens, thereby reducing the quality of a read image. To prevent detachment and deterioration of an image with a rise in temperature, the joint portion is preferably provided to one point at the center in the main-scanning direction.

Furthermore, the joint portion at which the rear-group lens and the image sensor are joined together is provided to both of the longitudinal side surfaces of the image sensor. With this, because the rear-group lens is joined to the image sensor at two opposing surfaces of the image sensor, the rear-group lens is not fixed in a cantilevered manner. This can prevent the rear-group lens from being vibrated in scanning, thereby providing an excellent image.

Furthermore, each of the joint portions at which the rear-group lens and the image sensor are joined together is provided at the center of the image sensor in the main-scanning direction. This can prevent detachment of the rear-group lens and deterioration of an image with a rise in temperature even if the image sensor and the rear-group lens have different coefficients of liner expansion.

According to the present invention, the relative position between the rear-group lens and the image sensor can be adjusted. Furthermore, the present invention provides a document scanning module that has a short conjugation length and a small scanner unit and that ensures high imaging performance.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A document scanning module comprising:
an image sensor; and
imaging lenses that focus light reflected from a document onto the image sensor to form an image, wherein
the imaging lenses include
a front-group lens arranged on a document side, and
a rear-group lens arranged on an image sensor side and having a width in a main-scanning direction,
the rear-group lens includes an attachment portion extending toward the image sensor, and
the attachment portion is joined to a longitudinal side surface of the image sensor.

2. The document scanning module according to claim 1, wherein
a joint portion at which the rear-group lens and the image sensor are joined together is provided to both of longitudinal side surfaces of the image sensor.

3. The document scanning module according to claim 1, wherein a joint portion at which the rear-group lens and the image sensor are joined together is provided at center of the longitudinal side surface of the image sensor in the main-scanning direction.

4. An integral scanning unit comprising the document scanning module according to claim 1.

5. An image reading device comprising the document scanning module according to claim 1.

6. An automatic document feeder comprising the document scanning module according to claim 1.

7. An image forming apparatus comprising the document scanning module according to claim 1.
